(19) United States
(12) Patent Application Publication
(10) Pub. No.: US 2008/0286743 A1
(43) Pub. Date: Nov. 20, 2008

(54) SYSTEM AND METHOD FOR MANAGING AND DELIVERING E-LEARNING TO HAND HELD DEVICES

(75) Inventors: Keith O'Loughlin, Maynooth (IE); David Harrison, Maynooth (IE); Niall Darby, Blackrock (IE); Padraig Cummins, Dalkey (IE); Lorraine Moore, Dublin (IE)

Correspondence Address: HOGAN & HARTSON LLP, ONE TABOR CENTER, SUITE 1500, 1200 SEVENTEENTH ST, DENVER, CO, 80202, US

(73) Assignee: IFSC House, Dublin (IE)

(21) Appl. No.: 11/748,952

(22) Filed: May 15, 2007

(51) Int. Cl. G09B 5/00

(52) U.S. Cl. 434/365

(57) ABSTRACT

The disclosure relates generally to a system and method for providing e-learning to remotely located candidates. More particularly, is described a system and method for enabling a remotely located candidate to effectively complete an e-learning application using a handheld device.

### TECHNICAL FIELD

This invention relates generally to a system and method for providing e-learning to remotely located candidates. More particularly, the present invention relates to a system and method for enabling a remotely located candidate to effectively complete an e-learning application using a handheld device.

### BACKGROUND

Within the modern corporate environment there is an emphasis on continued training. Such on-going development includes upskilling a work force on their job requirements and also advising them of changes in the corporate environment. This continued requirement for on-going training has led to the development of a number of e-learning applications; a general term that is conventionally used to refer to computer-enhanced learning. Such e-learning typically includes the development of a computer delivered learning or training course that can be distributed across a network and simultaneously accessed by a number of different persons, each accessing the course through a dedicated interface. Traditionally this has been provided on a PC interface to the training course, whereby the person taking the course access the material of the course on their PC. This can be in the context of a standalone application that is executed on their PC or using a client/server model can provide access to a web delivered application which is provided remotely from the PC on a central server, or servers.

As part of this development of elearning there has been a trend to standardize the specification of what determines elearning. A collection of standards and specifications for web-based elearning have been developed called Sharable Content Object Reference Model (SCORM). This model defines communications between client side content and a host system called the run-time environment (commonly a function of a learning management system that enables the management and delivery of online content to learners.) The use of such a model enables the provision of a web-based application which provides “anytime, any place, any pace” access to learning content and administration.

Despite these advances, there are constant developments in elearning. Some of the recent moves have been to what is termed mlearning or mobile learning. In such arrangements, the user taking the course accesses the course material through their mobile or handheld device such as a PDA or smartphone—the type of mobile telephone that has enhanced data processing and connectivity characteristics. Using such a technology it is possible for the user to move away from the PC environment and to access a course through the connectivity of their PDA. Such access is an improvement in that the course may be taken at any time and place where connectivity is available.

However connectivity is not always available and as a result there have been certain mlearning applications or courses that reside on the mobile device. With these applications there is a difficulty in that the administrators of the course cannot maintain an overview of the progress that each party taking the course has made. Effectively each of the mobile learning applications are stand-alone software applications, and have no interaction with the content provider. In this way it is reliant on the person taking the mlearning application to adhere to the requirements to complete the course—there is no audit of their performance. Furthermore there are difficulties in providing new and appropriate course material to a number of remote users, in that the software and courseware are not separated. Yet a further problem arises with the fact that mlearning applications do not use elearning standards such as SCORM.

Therefore despite the advances in the field, the industry is in need of more efficient systems and methods for providing e-learning to remotely located candidates.

### SUMMARY

These and other problems are addressed in accordance with the teaching of the present invention which provides a method and system for providing e-learning to remotely located candidates. Such a system may be implemented in a variety of ways, including one or more computer programs which are storable on a computer readable medium and which include computer logic which is executable on one or more handheld devices and which enables the handheld devices to interact with a central server so as to establish a remote overview of access to specific applications executed on the handheld device.

Other systems, methods, features, and advantages of the present invention will be, or will become, apparent to one having ordinary skill in the art upon examination of the following drawings and detailed description. It is intended that all such additional systems, methods, features, and advantages included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a graphical representation of a computer based elearning system in accordance with the teaching of the invention.

FIG. 2 is an example, in simplified form, of typical external components of a mobile handheld device for use with a system of the present invention.

FIG. 3 shows internal components of a device of FIG. 2 FIG. 4 shows in a flowchart a first deployment route for providing the handheld device with functionality according to the teaching of the invention.

FIG. 5 shows in a flowchart a second deployment route for providing the handheld device with functionality according to the teaching of the invention.

FIG. 6 shows in a flowchart sequence how a user may access courseware on their mobile device and how the handheld device may be configured to update the remote server as to the status of courseware conducted on the handheld device.

FIG. 7 shows how the architecture of FIG. 1 may be scaled to provide a distributed architecture having a plurality of levels.

### DETAILED DESCRIPTION

The invention will now be described with reference to exemplary embodiments which are provided to assist in an understanding of the teaching of the invention but are not to be construed as limiting the invention in any way except as may be deemed necessary in the light of the appended claims.

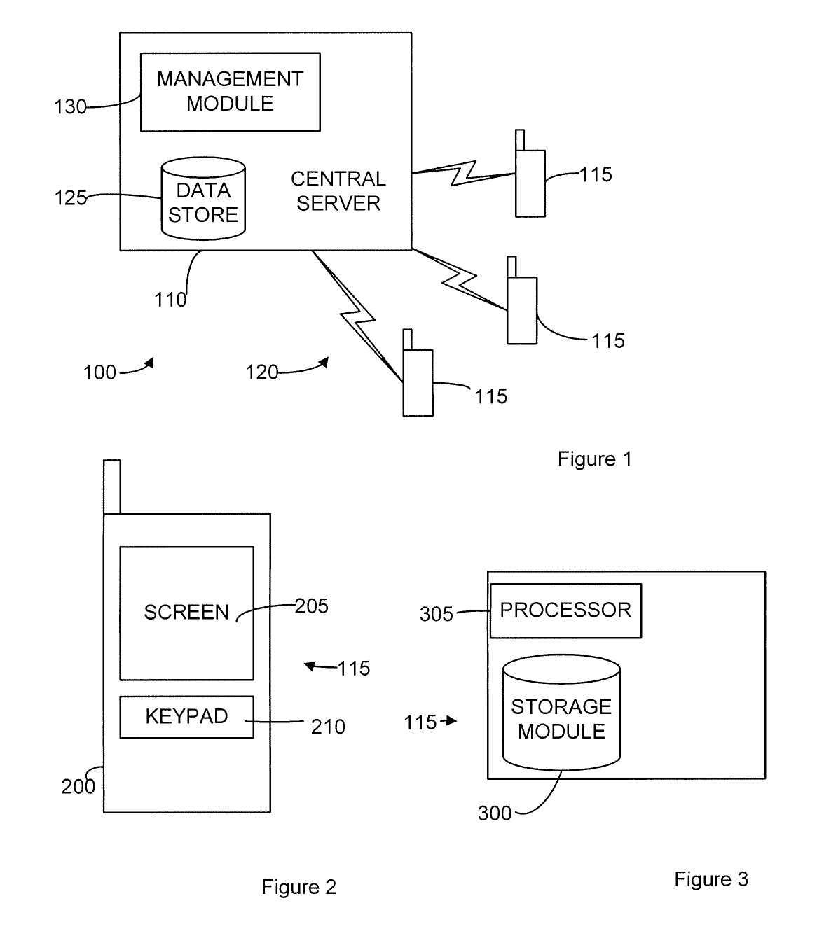

As shown in the schematic of FIG. 1, a system 100 according to the teaching of the invention includes a central server 110 which is configured to communicate with one or more remote handheld devices 115 over a communication network 120. Such a network is typically a wireless network providing data transfer protocols such as GPRS or 3G. The handheld devices may include such devices as personal digital assistants (PDAs) or smartphones such as those manufactured and provided by Sony Ericsson™, Nokia™, Samsung™, Blackberry™ or the like. For the sake of convenience the invention will now be described with regard to an implementation on a Blackberry™ device, but it will be understood that this is purely exemplary of the type of device that could be used to implement the teaching of the invention. The server 110 desirably includes convention computer architecture such as memory, processors, i/o devices and the like, as will be well appreciated by those skilled in the art. For the sake of clarity such conventional architecture components will be omitted from the following description.

Within the server 110 is provided a management module 130 which is useable to administer the delivery and tracking of a number of courseware modules to definable handheld devices. The management module 130 is interfaceable with a datastore 125 which is configured to store specific elements of courseware which are available for delivery to one or more of the handheld devices.

As shown in FIG. 2 a typical handheld device 115 which is useful in implementing the teaching of the invention includes a body or casing 200 which defines the exterior perimeter of the device. A graphical user interface or screen 205 is provided, typically of the dimensions 320×240 pixels. Such screen sizes are suitable for reading extended portions of text. To enable a user to interface with the device, a keypad 210 is typically provided. Depending on the features of the specific handheld device, this may include a QWERTY keypad, although the present invention is not to be limited to devices having such keypads.

Internally within the handheld device 115, is provided a processor 305 which is used to execute computer logic and a storage module 300 on which one or more courseware modules may be stored.

In accordance with the teaching of the invention, the handheld device 115 is provided with an executable application which enables the device to locally run one or more courseware modules. These modules are provided in a periodic fashion to the handheld device through an interfaces of the device 115 with the server 110. In order to initially configure the device for use with a system of the present invention it is necessary to first enable an installation of the executable application. In the context of a Blackberry device, the application is a series of computer executable files such as those implemented in Java™ code. As the application is deployed over a mobile data network it is desirable that the physical size of files be kept to a minimum and by using Java it is possible to provide an executable application of the order of about 150 kb.

In order to effect a system providing distance learning to one or more users it possible to push the necessary local application to each of the users or alternatively to enable the users to individually pull the application down from a central site. FIG. 4 shows a first arrangement for facilitating such an interface, that of a push arrangement. As show in FIG. 4 such an arrangement may leverage off conventional technology such as that provided using Blackberry Enterprise Server (BES). It will be understood that the BES is an example of a wireless platform that extends the benefits of a centralized network messaging and collaboration environment and other tools to mobile professionals and provides push-based access to email; calendar, contacts, tasks and notes; instant messaging; web-based applications and services and enterprise applications. Using such an architecture, the invention teaches putting the relevant application files onto the BES server and then selecting users who should receive these files (Step 400). Once this is defined the BES will effect a distribution of the relevant files to each of the selected users (Step 405). Such a process will appear seamless to the user of the handheld device and requires no interaction by them with the central server. Typical installation times are of the order of 60 minutes to 4 hours depending on level of connectivity and how busy the wireless network is.

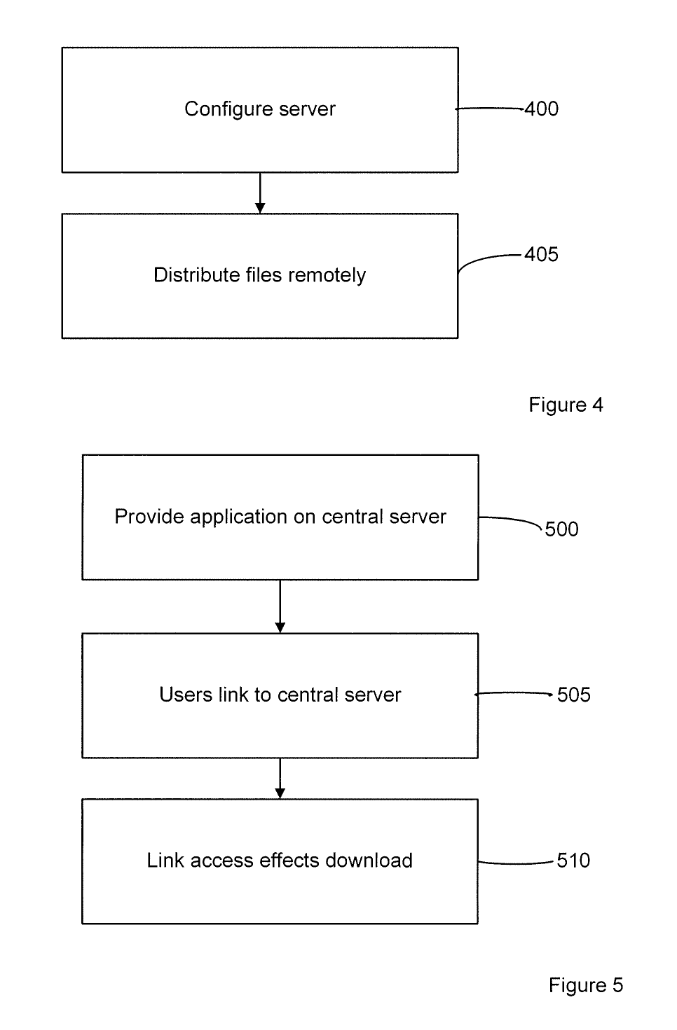

In an alternative arrangement, shown in FIG. 5, the user is required to pull the application from a central server. In a first step, the network administrator provides the application on the central server 110 (Step 500). The user may then actively link to this server from an email link provided to the user, or directly via a web browser provided on their smartphone (Step 505). The access to the site effects a download of the application (Step 510). This may require browser filter permissions on the local handheld device to be correctly set to enable the course to run correctly.

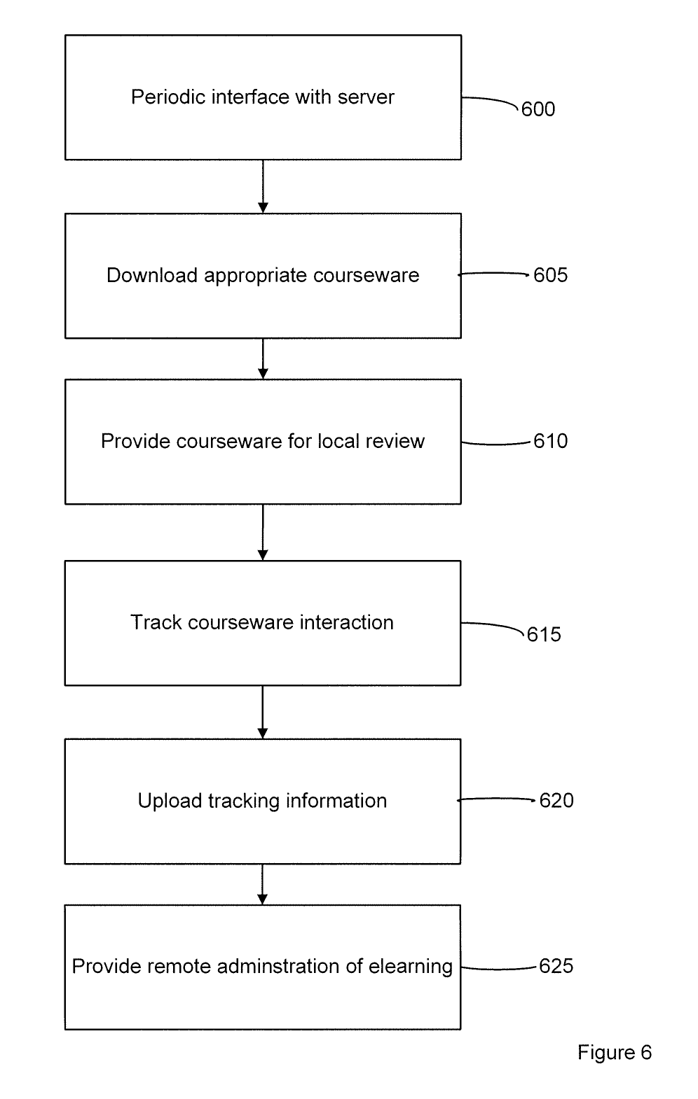

FIG. 6 shows how a handheld device, once suitably configured to installation of the local executable computer program may be used to deliver coursework to the user of the device. Once installed, the local application is configurable to periodically access the central server 110 to effect a download of the actual coursework that has been defined for distribution to the specific handheld device (Step 600). This interface may be effected through a communication initiated by the handheld device or through one initiated by the central server. In the former arrangement, the application may be set to poll for courses and download them periodically or the user can manually interface with the server to determine whether there are appropriate courses for that user to review. Courses are typically defined to be about 10 kb per minute of content such that a 25 minute course would be approximately 250 kb in size. It is desirable that the courses be provided in compressed format such as a zip file and also that they are SCORM compliant. In all cases once an appropriate set of courses are determined these are downloaded to the local handheld device (Step 605)

These coursework modules are then selectable by a local user who accesses these as desired and then completes them at a time dictated by the user (Step 610). As the coursework is locally stored on each handheld, this interaction does not require connectivity with the remote server. In this way as the system provides a standalone fully self consistent local application, the user may access and complete coursework at times and locations where connectivity is not available such as for example during flights or in regions of low data network coverage.

To ensure that the courses that are provided locally are completed satisfactorily, the local application 305 includes a tracking function which is configured to track and log the user interaction with each of the courses locally stored (Step 615). This tracking data can then be automatically uploaded to the central server together with any feedback data or alternatively the user may choose the appropriate time to upload their progress (Step 620). The tracking information is useful as it allows the remote administrator of the elearning modules to ensure that each of the remote parties are adequately completing their designated tasks and can also be used to effect a triggering of subsequent courses for delivery to a user, once they have completed designated tasks. It is desirable that the tracking module is configured to be SCORM compliant to ensure that the information is transmitted in a standardized fashion.

Heretofore a system in accordance with the teaching of the invention has been described with regard to a server/client architecture with the server hosting the centralized audit function of the courseware being taken by multiple remote users. Such a system is advantageous in that by separating courseware and the software required to run the courseware it is possible to provide new and personalized courseware on a per user basis on a push from the server, or indeed on a pull from the remote client. This does not require a continuous or synchronous link between the two, in that the information can be transferred between the client devices and the server during times of connectivity and does not require an always up link between the two, the system may operate in environments where only intermittent communication between the server and client is possible. In this way the system of the present invention provides a distributed learning environment. Operable in an asynchronous environment, the system can be scaled further.

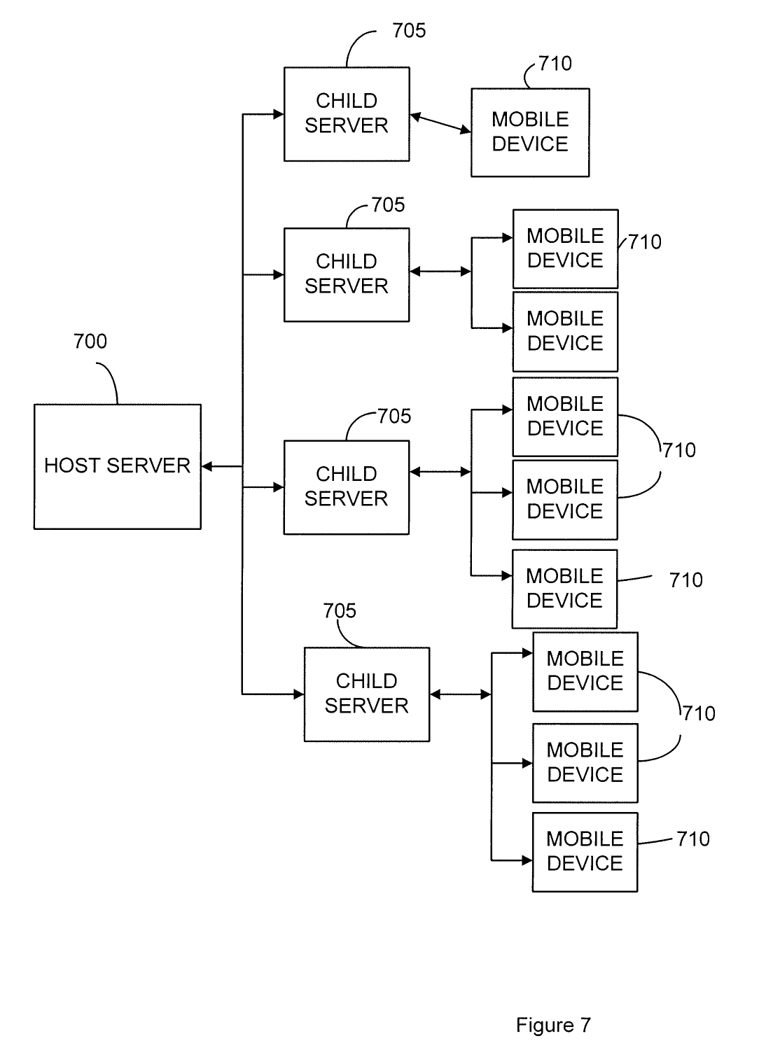

FIG. 7 shows an example where a host server 700 is used to distribute courseware to multiple child servers 705 which are located remotely from the host server. Each of the child servers may then be used to interact with a number of remote handheld mobile devices 710. The communication link between each of the host server 700, child servers 705 and mobile devices 710 does not require to be a continuous, it is sufficient that during times of interconnection that results of courseware that has been conducted further down the chain can be relayed back up to the host server through the chain, and modifications to courseware, or new courseware, that needs to be taken can be relayed down the chain. During off-connection times each of the entities within the chain are self consistent.

Such an architecture is desirable for a number of different reasons and environments. For example in providing on-going training to remote areas such as oil riggers it is possible for a land based server to be used as a central provider of courseware and audit functionality. The land based server interacts periodically with one or more child servers which are located on an oil rig. Such communication can be through a satellite or other wireless communication link or indeed by physically bringing a data storage device from the child servers back to land periodically. During the time that the child server is on the rig, it is capable of effecting communication with one or more devices, such as PDA's, tablet PCs or the like on which the workers will conduct their training. By associating a user logon with a specific set of courseware it is possible to log the activities of any one user and also to allow two or more users to use the same device. The devices 710 maintain a record of the courseware taken on their device, and then relay that back to the child server during periods of connectivity. The child servers 705 maintain records of a number of different devices and then relay that information back to the central host server 700 during periods of connectivity. In this way a central audit may be effected of the courseware taken by a number of different remote users in several locations.

By providing the courseware in a format that is SCORM or some other similar standard compliant it is possible to generate courseware for a traditional elearning environment where there are larger format screens etc, and then transpose that courseware to an mlearning environment through use of the in built functionality that is present in many mobile devices for viewing for example internet web sites or the like. Many of the browsers that are provided on a mobile device are capable of effecting changes in the format of the viewed material to ensure that it can be viewed sensibly on a much smaller screen that what it was intended for. By providing a distributed learning environment, it will be understood that the level of distribution can be scaled depending on the specifics of the deployment. By associating users with an identity and the courses that they have completed it is possible for management to centrally monitor both compliance with levels of learning required within a specific work environment and also to provide information as appropriate to selected ones of their workforce through a push model.

It will be understood that a system in accordance with the teaching of the invention uses functionality residing on traditional handheld devices such as i/o devices, screens, browser applications etc., but interfaces these with a courseware/coursework application that provides locally accessible coursework that is monitored and tracked locally. This local application is then interfaceable with a remote server to provide the remote server with an update of the local user progress through a defined list of coursework. By separating the software that is used to run the coursework from the coursework itself, it is possible on installation of the software to provide the user with a personalized level of coursework depending on their specific circumstances and speed of usage of the coursework. By including a tracking module such as a background listener which is executable and runs in the background, it is possible to monitor the usage and provide details to the central server.

Any process descriptions or blocks in figures, such as those in the accompanying Figures, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

At least the following is claimed:

1. A computer implemented distributed learning system including:
a. a central server having provided thereon a management module and a datastore configured to store one or more coursework modules, the management module being configured to manage a distribution of one or more of the stored coursework modules to one or more defined remote users, each of the remote users having an associated handheld device,
b. an application locally stored and executable on the handheld device of the remote user, the application being configured to enable an interface of the handheld device with the central server to obtain periodic downloads through a wireless communication network of selected coursework from the central server and to provide such coursework locally to the user,
c. a tracking module having components provided on each of the central server and the local handheld device, the tracking module component on the local handheld device being configured to track user interaction with the locally provided coursework and to periodically provide that information to the corresponding tracking module component on the server.

2. The system of claim 1 further including at least one child server interposed between the central server and the handheld devices, the child server being configured to interface between the central server and the handheld devices.

3. The system of claim 2 wherein the at least one child server includes elements of the tracking module such that a handheld device may provide details of coursework reviewed on the handheld device by a user, such details being storable locally on the at least one daughter server prior to transmission to the central server.

4. The system of claim 3 wherein the tracking module includes a data store configured to store details of the user who has conducted the coursework together with the details of the coursework completed.

5. The system of claim 1 wherein the wireless communication network is a mobile telecommunications data network.

6. The system of claim 1 wherein the wireless communication network is a local area network.

7. The system of claim 2 wherein the at least one child server is configured to communicate with the central server through a satellite data communication channel.

8. The system of claim 2 wherein the at least one child server is configured to communicate with the central server through an intermittent physical connection.

9. The system of claim 1 wherein the coursework is provided in a standardized format.

10. The system of claim 9 wherein the standardized format is SCORM compliant.

11. The system of claim 1 wherein the management module includes an audit function.

12. The system of claim 1 wherein the management module includes functionality that allows a selective transmission of coursework to a subset of all defined remote users.

13. The system of claim 1 wherein the communication between the central server and the remote users is asynchronous.

14. A method of delivering learning coursework to two or more remote users, the method including:
a. providing a central server having provided thereon a management module and a datastore configured to store one or more coursework modules, the management module being configured to manage a distribution of one or more of the stored coursework modules to one or more defined remote users, each of the remote users having an associated handheld device,
b. providing an application which may be distributed to, locally stored and executed on the handheld device of the remote user, the application being configured to enable an interface of the handheld device with the central server to obtain periodic downloads through a wireless communication network of selected coursework from the central server and to provide such coursework locally to the user,
c. providing a tracking module having components provided on each of the central server and the local handheld device, the tracking module component on the local handheld device being configured to track user interaction with the locally provided coursework and to periodically provide that information to the corresponding tracking module component on the server.

15. The method of claim 14 further including providing at least one child server interposed between the central server and the handheld devices, the child server being configured to interface between the central server and the handheld devices.

16. The method of claim 15 wherein on providing the at least one child server the method includes an installation of elements of the tracking module on the at least one child server such that a handheld device may provide details of coursework reviewed on the handheld device by a user, such details being storable locally on the at least one child server prior to transmission to the central server.

17. The method of claim 14 wherein the provision of the tracking module includes a configuration of a data store to store details of the user who has conducted the coursework together with the details of the coursework completed.

18. The method of claim 14 wherein including a configuring of each of the server and handheld devices to communicate with one another via a mobile telecommunications data network.

19. The method of claim 15 including a configuring of the child server and central server to communicate with one another through a satellite data communication channel.

20. The method of claim 14 including providing the coursework is provided in a standardized format which is SCORM compliant

21. The method of claim 14 including auditing the management module.

22. The method of claim 14 including providing a selective transmission of coursework to a subset of all defined remote users.

23. A distributed mobile learning system providing a delivery of mobile learning coursework to a plurality of users each having a wireless handheld device associated therewith, the system including a computer software element and a coursework module element, the computer software element being separated from the coursework module element and being configured to being executable on a wireless handheld device, and wherein subsequent to execution of the wireless device on the wireless device one or more coursework modules may be distributed to the wireless device from a central server where they are locally executed on the handheld device.

24. The system of claim 23 wherein the computer software element includes a tracking module configured to monitor the local usage of the coursework modules and to provide a report of that usage to the central server.
